(19) United States
(12) Patent Application Publication
(10) Pub. No.: US 2012/0246672 A1
(43) Pub. Date: Sep. 27, 2012

(54) SYSTEM AND METHOD FOR PROTECTING ADVERTISING CUE MESSAGES

(76) Inventors: Avinash Sridhar, Plainsboro, NJ (US); David Anthony Campana, Princeton, NJ (US); Alan Jay Stein, Princeton Junction, NJ (US); Jeffrey Adam Bloom, Princeton Junction, NJ (US)

(21) Appl. No.: 13/514,396

(22) PCT Filed: Dec. 16, 2009
(86) PCT No.: PCT/US09/06569

§ 371 Date: Jun. 7, 2012

(51) Int. Cl. H04N 21/2347

(52) U.S. Cl. 725/31

(57) ABSTRACT

An apparatus and method for encoding and decoding a broadcast data stream that includes encrypted advertisement cue messages. The encrypted advertisement cue message data representing a advertisement to be inserted into a stream and data representing an insertion time within said broadcast data stream that is associated with said advertisement. The advertisement cue messages are encrypted and encrypted using a encryption technique. The encrypted advertisement cue message masks the insertion time for the advertisement and prevents automatically skipping of the advertisement data.

### FIELD

The present arrangement provides a system and method that cryptographically protects advertising cue messages to prevent unauthorized modification of advertisements inserted into a content data stream.

### BACKGROUND

A majority of the revenue of a conventional broadcasting system is made from advertising. Advertisements are introduced between segments of actual programming or in the form of product placement within the content program being broadcasted to the user. Typically, advertisers supply advertisement content to a broadcaster which is interspersed and displayed within a broadcast content stream according to an advertisement schedule. The advertisement schedule includes times for displaying a advertisement and the position within the broadcast stream that the advertisement is to be displayed. This schedule is generally determined by a contractual or other agreement between the advertiser and the broadcaster and may be facilitated by an advertisement agency and/or media buying professional who is responsible for creation and placement of the advertisement in a certain program to be broadcasted at a time. Alternatively, advertisers are increasingly relying on product placement within a broadcasted program in order to promote their products. These instances are similarly governed by contractual relationships. In view of the significant financial resources expended by companies to create and place advertisements, it is desirable to ensure that these placements cannot be circumvented without authorization from the creator/owner of the advertisement.

Once created and scheduled, data representing an advertisement is inserted with the help of devices called splicers. The Society of Cable Telecommunications Engineers (SCTE) sets forth standards that are implemented by splicers and other network devices that enable access to a live broadcast stream. For example, the ANSI/SCTE 30 2006 standard entitled “Digital Program Insertion Splicing API” describes the mechanism by which a live stream from a broadcaster may be accessed in order to insert an advertisement within the stream to be displayed to a user. Additionally, the ANSI/SCTE 35 2007 standard entitled “Digital Programming Insertion Cueing Message” describes the process for inserting cue messages which signify which ad will be inserted as well as the position in the live stream. However, the use of the standard cue messaging protocol has certain drawbacks associated therewith. For example, because these standards are open, any device that is capable of implementing splicing (to perform targeted advertising) may read the ad insertion cue messaging protocol and use this information to replace or skip the advertisements. This feature may be implemented in devices that record a live broadcast, for example like a Personal Video Recorder(PVR) device. Therefore, it is desirable to prevent unauthorized skipping or replacement of advertisement content.

An exemplary system 100 for inserting advertisement into a live broadcast stream is described in FIG. 1. A broadcaster provides a data stream including original content 102 for broadcast for viewing by a plurality of users. For example, the data stream may be encoded in MPEG-2 format. However, any other digital data encoding scheme may also be used. Additionally, a source of advertisement information 104 provides data representing at least one advertisement to an advertisement storage system 106. The advertisement data stored within storage system 106 is provided to a splicer 110 that selectively inserts a advertisement data into the original content broadcast stream 102. A scheduling and management system 108 selectively provides schedule data to the storage system 106 which directs the storage system 106 to provide advertisement data to the splicer 110 for insertion into the broadcast data stream 102. The insertion of the advertisement data 104 from storage system 106 is facilitated by a control signal 109 that implements SCTE 30 standard that controls the insertion of the selected advertisement data 104. The splicer 110 outputs a modified broadcast stream 112 that includes the original content 102 and advertisement data 104 for transmission via a communication network to a plurality of end users who decode and view the original content and advertisement data.

An exemplary modified content stream 112 output by splicer 110 in FIG. 1 is depicted in FIG. 2. The modified stream 112 includes a plurality of data blocks that each include a type of content. For example, the modified stream 112 shown herein represents a portion of a data stream that is being broadcast to a plurality of users. Block 201 includes a portion of data representing the original content 102 being broadcast to a user. For example, block 201 may include a data representing a portion of a television program encoded in a known manner for broadcast to users. Block 202 of the modified stream 112 includes advertisement data provided from the storage server 106 (FIG. 1) at the direction of the scheduling system 108 (FIG. 1). In addition to the advertisement data, block 202 may include a marker that signals the receiving device that the advertisement data 104 should be inserted at that point. Block 203 includes a tone which identifies that that advertisement data has ended and that the receiver should switch back to displaying the program data which follows in block 204. While the modified stream 112 is shown as including four data blocks, it should be understood that the stream 112 can include any number of data blocks in order to completely transmit the requested original content and all associated advertisement data to a destination system for decoding and display thereof.

FIG. 3 depicts another conventionally targeted advertising system 300. In a targeted advertising system, the broadcast data stream 302 is formatted similarly to the modified stream 112 of FIGS. 1 and 2. Unlike the previously discussed advertisement systems, the stream 302 received by a targeted advertising stream format 302 may or may not be modified by a splicer prior to broadcast. The stream 302 represents a portion of a broadcast data stream that is received by a user. The stream includes a first data block 303 that includes a portion of data representing the original content and a second data block 304 that includes a marker for advertisement data. Alternatively, block 304 may include advertisement data along with the marker data for advertisement data. Block 305 includes a tone that identifies that the advertisement data segment has ended and block 306 includes an additional portion of the original content being broadcast. Targeted advertisement system 300 employs a set top box 308 present at the end-user premises that detects the advertisement markers in block 304 and uses a local source of advertisement data which is inserted into the stream 302 at the marker position. In the instance that block 304 also includes advertisement data, the set top box 308 displays the advertisement data identified in block 304 and uses the local source of advertisement data to acquire advertisement data which is inserted into the stream 302 at the marker position.

It is possible to detect the markers in the modified content stream and circumvent the viewing of the inserted advertisements. However, such circumvention is not advantageous to the advertisers or the broadcasters that rely on the inserted ads for revenue.

### SUMMARY

In one embodiment, an apparatus for encoding a broadcast data stream is provided. The apparatus includes a message processor that generates an advertisement cue message including data representing a advertisement to be inserted into a stream and data representing an insertion time within the broadcast data stream that is associated with the advertisement. An encryption processor is coupled to the message processor and conditioned to encrypt the advertisement cue message using an encryption technique. The encrypted advertisement cue message masks the insertion time for the advertisement and prevents automatically skipping of the advertisement data. An encoder is coupled to the encryption processor and conditioned to encode a modified broadcast data stream including the encrypted advertisement cue message and program data from a content provider.

In another embodiment, an apparatus for decoding a broadcast data stream is provided. A receiver receives a broadcast data stream that includes encrypted advertisement cue messages, the encrypted advertisement cue messages includes data representing a advertisement to be inserted into a stream and data representing an insertion time within the broadcast data stream that is associated with the advertisement. A decryption processor is coupled to the receiver and conditioned to decrypt the advertisement cue message using a decryption key. The decrypted advertisement cue message identifying the insertion time for the advertisement and enables display of the advertisement data. A decoder is coupled to the decryption processor and conditioned to decode the broadcast data stream including the encrypted advertisement cue message and program data from a content provider.

Additional features and advantages of the arrangement are apparent from the following detailed description of illustrative embodiments which proceeds with reference to the accompanying figures.

### BRIEF DESCRIPTION OF THE DRAWINGS

FIG. 1 depicts an example advertisement insertion system;

FIG. 2 depicts an example broadcast data stream including advertisement data;

FIG. 3 depicts an example targeted advertising system;

FIG. 4 depicts an encoder for encrypting advertisement cue messages for broadcast to at least one end-user according to present arrangement;

FIG. 5 depicts an example data stream including encrypted advertising cue messages according to the present arrangement;

FIG. 6 depicts an example set top box able to decode the encrypted advertising cue messages according to the present arrangement;

FIG. 7 depicts a targeted advertising system according to aspects of the present arrangement;

FIG. 8 is a flow diagram describing an aspect of the present arrangement; and

FIG. 9 is a flow diagram describing another aspect of the present arrangement.

### DETAILED DESCRIPTION OF THE EMBODIMENTS

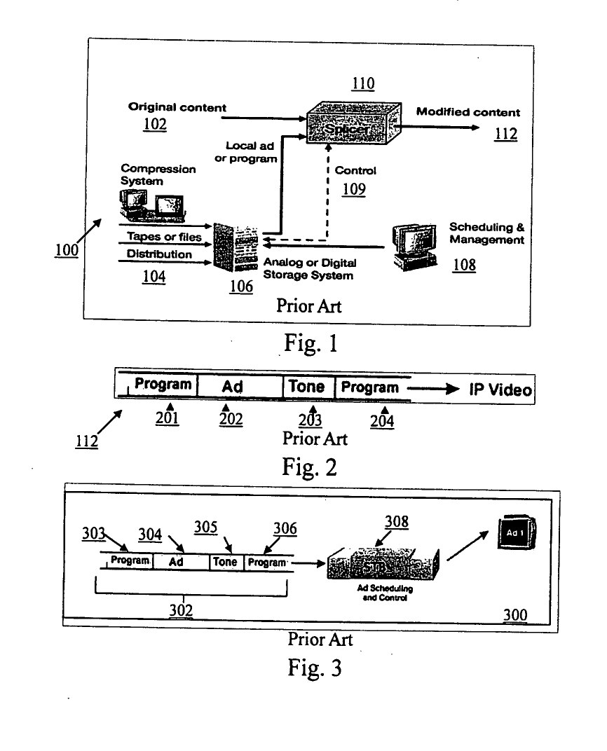

A significant drawback associated with the systems described above with respect to FIGS. 1-3 is that data streams that include cue messages for advertisement insertion are detectable by a set top box (STB) and/or a personal video recorder (PVR) for use in skipping an advertisement. Therefore, it is desirable to provide a system and method to prevent this by cryptographically protecting advertising cue messages that are transmitted in a broadcast data stream in order to ensure that unauthorized decoding equipment cannot automatically skip advertisements using advertisement cue messages transmitted in a data stream.

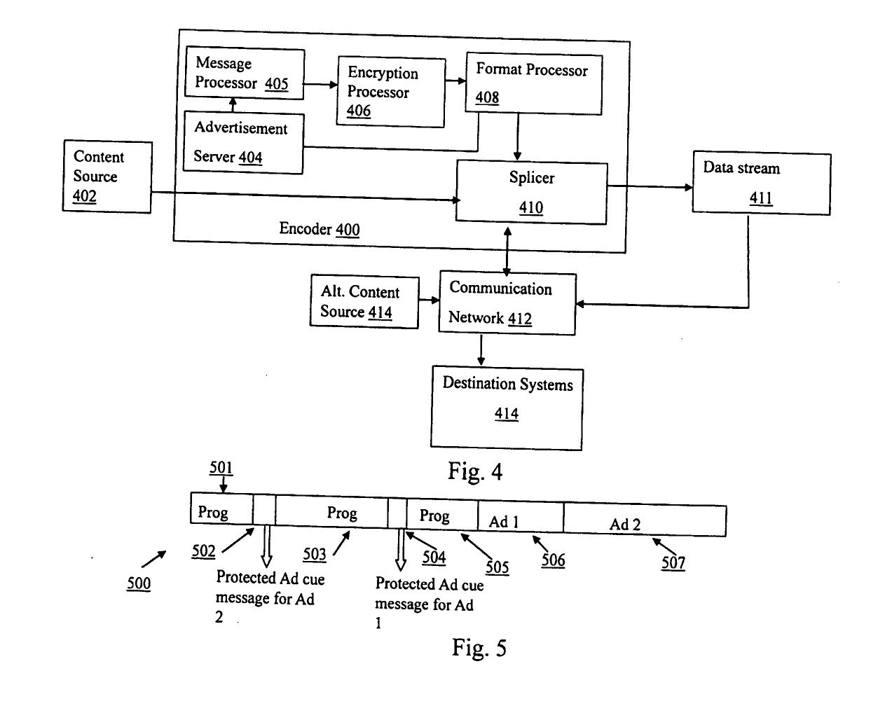

An exemplary encoder 400 for encoding cryptographically protected advertising cue messages is shown in FIG. 4. The encoder 400 is coupled to a source of content 402 that is broadcasted over a communications network for receipt by a user. As used herein, the term content includes audiovisual data that is broadcasted for receipt by a plurality of users, for example, a digital television data stream or audiovisual data that is available in response to user request, for example On-Demand video programming. Content may also include multimedia data that is communicated over an IP-based network such as the internet. As described above, the business model implemented by broadcasting companies involves selling advertisement time within a content stream that enables product information to be provided to the end user while the end user is viewing the content.

The encoder 400 includes an advertisement server 404 that may include a source of advertisement data for insertion into a broadcast data stream. The advertisement server 404 may also include advertisement schedule and management functions that facilitate the proper insertion of a advertisement data at a time within a data stream. The advertisement server 404 is coupled to a message processor 405 which generates data representing advertising cue messages that identifies a time within the broadcast data stream that advertisement data will be displayed to the user. Each advertisement set to be displayed in a broadcast includes an associated cue message generated by the message processor 405. The advertising cue messages generated by the message processor 405 may include digital cue messages that are inserted within a broadcast data stream. Alternatively, the advertising cue message may include a watermark that is incorporated within the content being broadcast to the user. The encryption mechanism for both the digital cue message and watermark will be discussed below.

The message processor 405 is coupled to an encryption processor 406. The encryption processor 406 applies an encryption technique for encrypting each advertising cue message. The encrypted cue message may be in any encryption format such as AES, for example. This format is provided for exemplary purposes and any standard or proprietary encryption algorithm may be implemented by the encryption processor 406 when encrypting cue messages. In another embodiment, the encryption processor 406 may implement a form of key management (e.g. public/private key management systems) whereby the cue message is encrypted using a key which is then required for decoding when the stream is received. The keys used to encrypt the advertising cue message, and thus necessary for decrypting the cue message, may be provided via a communication network to an end user's set top box enabling decoding of these cue messages. For example, keys to help in decoding the cue messages could be sent offline or by including the keys in the device at the manufacturing stage. This provides a first level of protection from unauthorized decoding of cue messages. In the event that the key management system becomes compromised when the device is in the field of operation, the manufacturer or broadcaster could provide a mechanism whereby the keys for decoding these cue messages could be updated regularly over a some threshold period of time over a network or hardware dongle, for example. The generation of encrypted advertisement cue messages advantageously prevents unauthorized skipping of advertisement data by unauthorized decoding systems. By encrypting the cue message, any system that does not have the associated decryption mechanism will not be able to accurately determine when advertisement data is scheduled to be displayed and thus is unable to automatically skip advertisement data. Moreover, encrypting advertising cue messages enables content providers (i.e. cable/satellite companies) to offer additional services whereby an authorized decoding device would be able to automatically skip advertisement data because these systems are able to decipher the position within the stream where the advertisements are scheduled to be displayed.

Additionally, the encryption processor 406 may encrypt dummy cue messages that may be inserted into an encoded data stream 411. The dummy cue messages are provided within the data stream 411 to deceive a destination system that does not have the proper decryption circuitry and/or key. This advantageously provides an additional level of protection from unauthorized skipping of advertisements. For example, systems that are unable to decrypt the cue message may attempt to predict a time at which the advertisement will be displayed based on the receipt of a message that they are unable to decode due to the encrypted cue message. Based on this prediction, these systems may use this to skip a segment of the stream that is believed to contain advertisement data. Thus, the encryption processor 406 of the encoder 400 generates data representing dummy cue messages and encrypts these messages according to the encryption scheme discussed above. The dummy cue message includes data identifying the message as a dummy message and, upon decryption by a destination system 414, directs the destination system 414 to ignore the message and continue decoding the data stream 411.

The encrypted cue message associated with advertising data is provided by the encryption processor 406 to a format processor 408 coupled thereto. Additionally, any encrypted dummy cue messages may also be provided by the encryption processor 406 to the format processor 408. The format processor 408 receives all of the encrypted cue messages for the advertisements and any dummy cue messages that are to be included within a content data stream. The format processor 408 is also coupled to the advertisement server 404 and is provided with advertisement management data for use in generating format data to format the data stream for broadcast. The format data includes a time at which a advertisement is to be played during the broadcast and a position within the data stream that the encrypted cue message associated with that advertisement is to be placed. In the instance when encrypted dummy cue messages are included, the format data further identifies a position in the content stream where the encrypted dummy cue messages are to be placed. The format data includes data values that identify the positions within the data stream of the payload audio-video data that contains the content being broadcasted and data values identifying at least one of (a) a position of the respective encrypted advertisement cue messages, (b) a position of an encrypted dummy cue message, (c) a position of respective advertisement data and (d) a placeholder for advertisement data to be inserted upon decoding of the data stream. The position data used to format the data stream may be generated randomly by the format processor 408 and includes ordering data provided to the destination systems for use in ordering the segments of the data stream upon decoding.

The format data generated by the format processor 408 is provided to the splicer 410 which receives the advertisement data from the advertisement server 404 and content from the content source 402 to produce a broadcast data stream 411 that is communicated via a communication network 412 for receipt by at least one destination system 414. Alternatively, the splicer 410 may be connected to the communication network 412 and may receive content from an alternate content source 414 for use in producing the data stream 411.

In an alternate embodiment, the cue messages are digital watermarks that are incorporated into the broadcast data stream. Digital watermarking is the process of embedding information into a digital signal. The signal may be audio, pictures or video, for example. Watermarks are hidden messages in any of the audio or video payload being transmitted. If the signal is copied, then the information is also carried in the copy. Watermarks may be added into the audio or the video track of the broadcast. In this embodiment the encryption processor 406 implements a watermarking algorithm whereby a watermark associated with an advertisement is generated and embedded within the content data by the encryption processor 406.

The advertisement server 404 generates a watermarking cue message that includes timing information identifying the time at which the advertisement is presented. The watermarking cue messages are provided to the encryption processor 406 and are encrypted using the key management encryption described above. These encrypted watermarking cue messages act as signals and the time information contained within them are used to insert data representing the advertisement. The encrypted watermark cue messages are provide to the format processor 408 which generates format data as discussed above. The format data is provided to the splicer 410 which generates the broadcast data stream 411 including the watermark cue messages, the content data that has been modified to include the watermark associated with the advertisement data and the advertisement data to be displayed. It should be noted that each broadcast stream generated by the splicer 410 will include a plurality of watermark cue messages, watermarks and advertisement data.

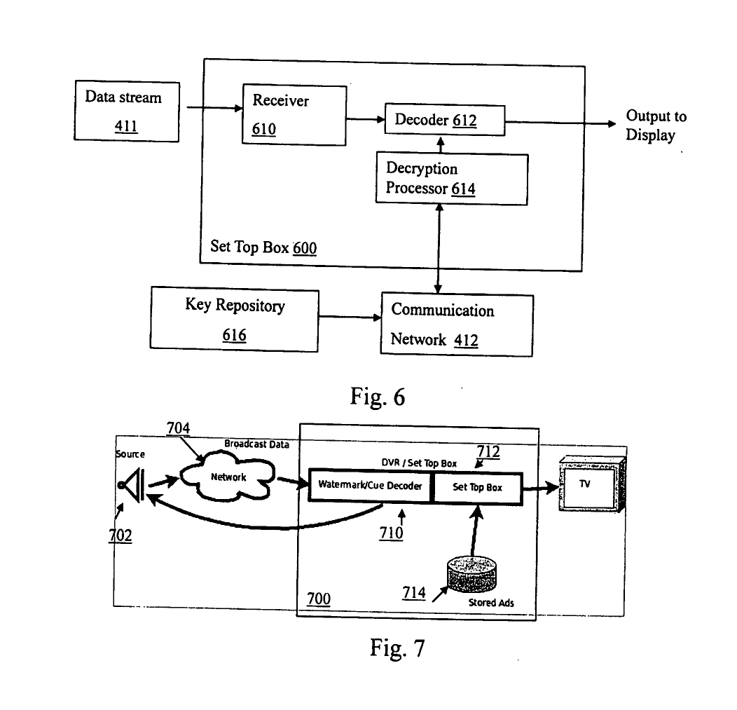

A portion of an exemplary formatted broadcast data stream 500 including encrypted cue messages is depicted in FIG. 5. The portion of the stream 500 shown herein includes data blocks 501-507. Data blocks 501, 503 and 505 include segments of the content data that comprise the program displayed to the user. Data block 502 includes an encrypted cue message associated with a second advertisement. The data representing the second advertisement is contained in block 507. Data block 504 includes an encrypted cue message associated with a first advertisement and the data representing the first advertisement is provided in data block 506. The encrypted cue messages are protected and are only decipherable by a STB that has the proper decoding hardware and key for decoding the messages. Upon receipt by an authorized system, the stream 500 is decoded as will be discussed hereinafter with respect to FIG. 6. The authorized system will display the program data in block 501 and at the conclusion thereof and in response to decryption of the advertisement cue message in block 502, display the advertisement data in block 507. At the end of the advertisement data, additional program data contained in block 503 will be displayed. At the conclusion of this segment of program data, the advertisement cue message in block 504 is decrypted and advertisement data contained in block 506 is displayed. The user returns to the program data contained in block 505 at the conclusion of the advertisement data from block 506. Additionally, while not specifically shown in FIG. 5, the stream 500 may also include blocks that correspond to the dummy cue messages that are generated by the encryption processor 406 in FIG. 4. These dummy cue message blocks may be located at any point in the data stream 500.

FIG. 6 depicts an exemplary block diagram of a set top box 600 for decoding and decrypting the encrypted data stream 411 generated by the encoder 400 described above in FIG. 4. The set top box 600 includes a receiver 610 that receives the data stream 411. The set top box 600 further includes a decoder 612 coupled to the receiver and a decryption processor 614 coupled to the decoder 612. The data stream 411 is provided from the receiver to the decoder 612 for decoding thereof. The decoder 612 parses the data blocks that comprise the data stream 411 to identify the content contained within each respective data block. Certain aspects of decoding of an audio-video data stream 411 to identify data in data blocks is performed in a known manner and will not be discussed. In addition to known decoding techniques and algorithms employed by decoder 612, decoder 612 identifies data blocks in data stream 411 that include encrypted cue messages. Upon identifying that a data block in the data stream 411 represents an encrypted cue message, decoder 612 provides the data representing the encrypted cue message to the decryption processor 614. The decryption processor 614 decrypts the encrypted cue message using a decryption key. The decryption key may be at least one of provided by the set top box manufacturer and provided by the broadcast company. Additionally, the decryption processor 614 may be coupled to a key repository 616 via the communication network 412 which enables automatic or manual updates of the keys used for decrypting the cue messages. In the event a key has expired or has been compromised, the decryption processor 614 may automatically obtain a new key. Alternatively, the cable provider may signal the set top box to direct the decryption processor 614 to obtain a new key from the key repository 616 at a time point or during a time interval.

Upon decryption of the cue message in data stream 614, the decoder 612 uses data within the cue message to determine the time and display of the advertisements transmitted in the data stream 411 with respect to the original content in the data stream 411. Moreover, once decrypted, the decoder 612 may use the data included in the cue message to automatically skip the associated advertisement data. This may be used as part of an additional subscription based service whereby the cable operator, for an agreed upon fee, enables the user to have a number of advertisements automatically skipped and not displayed when the user is viewing the original content.

10024) While FIG. 6 is described with respect to encrypted cue messages, it should be appreciated that similar elements of the set top box 600 are able to decrypt the encrypted watermarks that are described above with respect to the alternate embodiment in FIG. 4. In a data stream 411 that includes the original content embedded with encrypted watermarks, the decoder 612 identifies the location of the watermark and provides data representing the encrypted watermark to the decryption processor 614. The decryption processor 614 uses the decryption key to decrypt the watermark data and the decrypted content is provided back to the decoder 612 which is able to selectively insert the advertisement data associated with that water at the desired position within the data stream.

The present arrangement provides an additional advantage when these encrypted data streams are received by a system that is unable to decrypt the cue or message, i.e. a legacy system. These legacy systems can receive the data stream but cannot recognize the cue messages because they are cryptographically protected. If these messages are sent such that they appear just prior to advertisement insertion, then a legacy terminal could attempt to predict a time point in the data stream whereby the advertisement is to be played and still try to perform ad skipping using the undecipherable message as a mark. The condition is mitigated by the system because the cryptographically encoded advertisement cue messages or watermarks could be inserted at random points in the stream. This way a legacy terminal will not know the difference between a legitimate cue message and a dummy cue message.

The decoder 612 automatically processes the data stream 411 to include the original content along with the appropriate advertisement data that is derived in response to the decryption of any cue messages by the decryption processor 614. This processed data stream is provided for output to a display device by the set top box 600. In operation, the user views the original content that is either broadcasted or requested by the user including the proper advertisements in the proper order.

FIG. 7 depicts an exemplary targeted advertisement system 700 (i.e. targeted to one or more users) that decrypts encrypted cue messages present in a data stream. In this embodiment, a content source 702 transmits a data stream including an encrypted cue message that is encrypted according to an encryption scheme over a communication network 704. The encrypted cue message includes data identifying a time at which a advertisement is to be displayed. Additionally, because this is a targeted advertisement system, the advertisement data is not encoded within the data stream. Rather, the advertisement data is inserted by the set top box of the user. Thus, the encrypted cue message may also include targeting data that identifies at least one of (a) a advertisement to be inserted, (b) a type of advertisement to be inserted in the data stream, (c) a style of an advertisement to be inserted in the data stream, (d) an advertisement including a group of products, (e) an advertisement including a specific product of a group of products, (t) viewer demographic data and (g) viewer preference data. This data is selectively used by the targeted advertisement system to select which advertisement is to be displayed at the associated time point of the data stream

The data stream is selectively received by the targeted advertising system 700. The targeted advertising system 700 includes a decoder 710 for decoding and decrypting the cue messages including in the received data stream. The decoder 710 is coupled to set top box 712 which is further coupled to a repository of advertisement data 714. FIG. 7 depicts the decoder 710 and set top box 712 as separate modules. However, it should be noted that the decoder 710 could be formed integral with the set top box 712. The decoder 710 operates in a similar manner as the decoder 612 and decryption processor 614 described above in FIG. 6. Decoder 710 implements a decryption algorithm using a decryption key in order to decrypt the cue messages. Upon decoding of the data stream and decrypting the cue messages, the set top box 712 analyses data in the decrypted cue message and acquires advertisement data from the repository 714 in response to the data included in the cue message. By using targeting data, the user is able to acquire and display an advertisement that is targeted to the user. Thus, system 700 can decode the cue messages and automatically insert advertisement data into the live stream from the advertisement repository 714. Additionally, the cue message may direct system 700 to insert advertisement data based on user profile information that is stored locally at the set top box 712. The ads would be inserted appropriately based on the information included in the cue messages.

While FIG. 7 is described with respect to decoding encrypted cue messages, it is also expected that watermark data and encrypted watermark messages may include similar targeting data as described above. In this embodiment, the decoder 710 decodes and decrypts watermark data to derive the target data for the data stream. The target data is employed by the set top box 712 to acquire the desired advertisement data for incorporation into the live data stream and which is displayed to the viewer.

The decoding and decryption devices described above in FIGS. 6 and 7 may be formed integrally within set top boxes that are distributed by content provider such as cable or satellite system operators. Alternatively, these devices may be stand alone devices that are selectively connectable to legacy set top boxes that would enable decoding and decrypting of data streams that include any of encrypted cue messages or watermark data. If embodied as a stand alone device including the circuitry described above, the device may be implemented at as an edge device at the initial point of connection with the user's premises as described above with respect to FIG. 7. Thus, decoding and decryption of the cue messages occurs prior to receipt of the signal by the respective set top boxes connected to display devices.

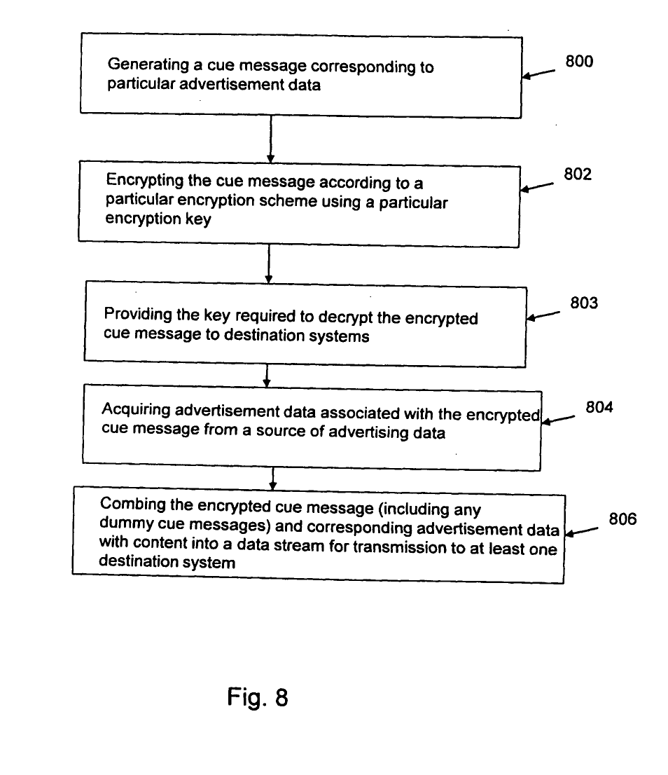

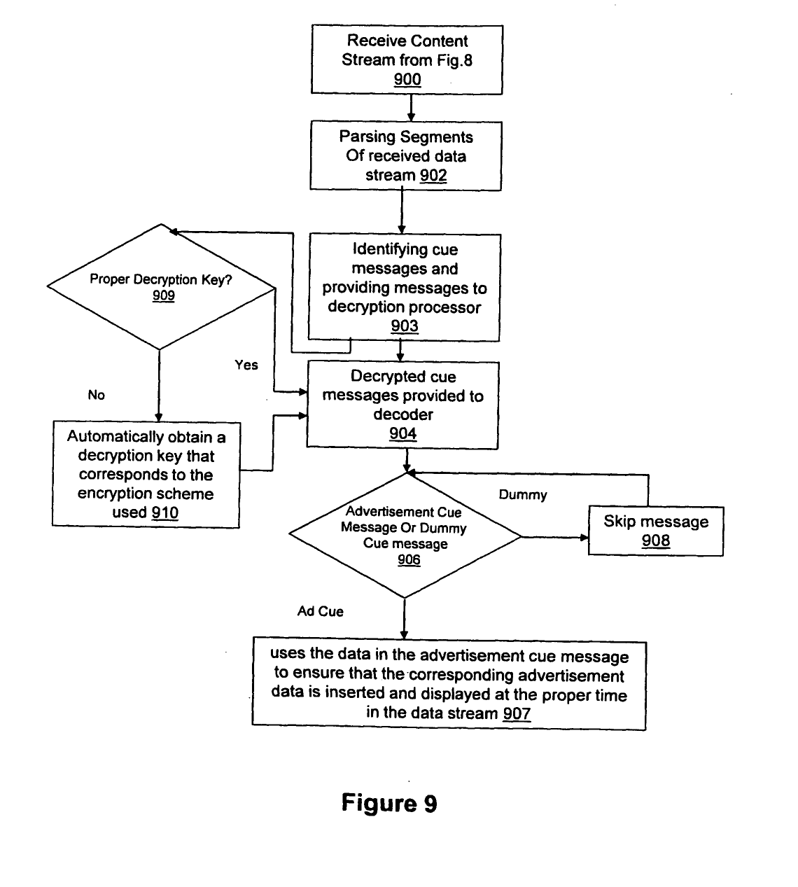

FIG. 8 is a flow diagram detailing an example method for generating a modified data stream including content data and encrypted cue messages that identify advertisement insertion points. At step 800, a cue message corresponding to advertisement data is generated. The cue message is encrypted according to a encryption scheme using a encryption key in step 802. The activity of encrypting the cue messages may also include encrypting dummy cue messages that do not correspond to advertisements but instead are used to prevent destination systems that are unable to decrypt the cue messages from anticipating advertisement insertion points and thereby attempting to skip a segment of the data stream believed to include advertisement data. In step 803, the key required to decrypt the encrypted cue message is provided to the destination systems thereby enabling the destination systems to decrypt the cue messages upon receipt thereof. Advertisement data associated with the encrypted cue message is acquired from a source of advertising data in step 804. The encrypted cue message (including any dummy cue messages) and corresponding advertisement data is combined, in step 806, with content into a data stream for transmission to various destination systems over a communication network for display by a user. The activity of described in step 806 may include generating format data that identifies the position of respective encrypted advertisement cue messages, encrypted dummy cue messages, advertisement data and content data. The format data may then be used when formatting the data stream that is transmitted to the destination systems.

FIG. 9 is a flow diagram detailing an example implemented by the destination system that decodes and decrypts a data stream generated in accordance with principles of the invention, such as the method of FIG. 8. In step 900, the data stream including encrypted advertisement cue messages, dummy cue messages, advertising data and content data is received at a set top box. The data stream is provided to a decoder that parses the segments of the data stream as in step 902. Upon determining that a segment of the data stream includes either an encrypted advertisement cue message or an encrypted dummy cue message, that segment of the data stream is provided in step 903 to a decryption processor that uses the key provided in step 803 in FIG. 8 to decrypt the cue message. In step 904, the decrypted cue message is provided to the decoder. The decoder parses the cue message to identify the data contained therein in order to determine the proper point for inserting the corresponding advertisement data into the content stream that is displayed to the user. The decoder determines if the decrypted cue message is an advertisement cue message or a dummy cue message in step 906. If the decrypted cue message is an advertisement cue message, the decoder in step 907 uses the data in the advertisement cue message to ensure that the corresponding advertisement data is inserted and displayed at the proper time in the data stream. Alternatively if the decrypted cue message is a dummy cue message, the message is skipped in step 908 and the process returns to step 906 to make additional determinations.

In an alternative embodiment, step 903 does not flow directly to step 904 as stated above. In the alternative embodiment, after step 903, the decryption processor queries whether or not the system has the proper decryption key in step 909. If the system possesses the proper key for decrypting cue messages at step 909, the process continues at step 904. If the key is improper, then decryption processor automatically obtains a decryption key that corresponds to the current set of encrypted cue messages from a key repository as shown in step 910 and then directs the operation of the system back to step 904 for properly decrypting the cue messages.

In operation the system described above with respect to FIGS. 1-9 advantageously provides for the control and management of advertisement data within a data stream. The system, by providing encrypted cue messages and/or watermark data within a data stream, prevents the unauthorized skipping of the advertisements intended to be displayed within a data stream. This provides for a higher return on investment for the advertisers because it increases the likelihood that the message will reach the intended viewer. Moreover, the system advantageously provides a mechanism that prevents legacy set top box systems from learning a pattern of advertisement display cues which may be used to predict when an advertisement is to be displayed and thereby skip that segment of the data stream. The dummy cue messages and the random ordering of encrypted advertisement cue messages in the data stream minimize the ability of legacy systems to derive a pattern for circumvention within a data stream and thus results in reliably displaying of the desired advertisement content. Furthermore, the system advantageously provides a revenue model whereby the systems that are able to decrypt the cue messages could be authorized to skip the associated advertisement data based on a subscription or contractual fee arrangement.

Although the arrangement has been described in terms of exemplary embodiments, it is not limited thereto. Rather, the appended claims should be construed broadly to include other variants and embodiments of the arrangement which may be made by those skilled in the art without departing from the scope and range of equivalents of the arrangement. This disclosure is intended to cover any adaptations or variations of the embodiments discussed herein.

1. An apparatus for encoding a broadcast data stream comprising:
a message processor that generates an advertisement cue message including
data representing a advertisement to be inserted into a stream and
data representing an insertion time within said broadcast data stream that is associated with said advertisement;
an encryption processor coupled to said message processor and conditioned to encrypt said advertisement cue message using an encryption technique, said encrypted advertisement cue message masks said insertion time for said advertisement and prevents automatically skipping of said advertisement data; and
an encoder coupled to said encryption processor, said encryption processor encoding a modified broadcast datastream including said encrypted advertisement cue message and program data from a content provider.

2. The apparatus of claim 1, wherein
said advertising cue message further includes data representing a source of source of said advertisement and further comprising;
an advertisement server coupled to said encoder and said message processor that provides data representing said advertisement in response to said advertisement cue message to said encoder for encoding said modified broadcast data stream.

3. The apparatus of claim 1, wherein
said advertisement cue message further includes:
data indicating that said advertisement is stored on a destination system, and
source information for said advertisement for insertion.

4. The apparatus of claim 1, wherein
said message processor generates a dummy cue message including data indicating that said dummy cue message is to be skipped upon decoding.

5. The apparatus of claim 1, wherein
said encryption processor automatically transmits an encryption key used to encrypt said advertisement cue messages to a destination system for use by said destination system for decoding said encrypted advertisement cue messages.

6. The apparatus of claim 1, further comprising
a format processor that generates format data defining a format for use by said encoder in generating said modified broadcast data stream.

7. The apparatus of claim 6, wherein
said format data identifies a position of respective encrypted advertisement cue messages with respect to advertisement data and content data within said modified broadcast data stream.

8. The apparatus of claim 6, wherein
said format processor generates format data by randomly positioning said encrypted advertisement cue messages within said modified broadcast data stream.

9. The apparatus of claim 1, wherein
said advertisement cue message is formed as a watermark, and
said encoder automatically incorporates said watermark into a content stream prior to encoding said modified broadcast data stream.

10. An apparatus for decoding a broadcast data stream comprising:
a receiver for receiving a broadcast data stream that includes encrypted advertisement cue messages, said encrypted advertisement cue messages including:
data representing a advertisement to be inserted into a stream, and
data representing an insertion time within said broadcast data stream that is associated with said advertisement;
a decryption processor coupled to said receiver, the decryption processor decrypting said advertisement cue message using a decryption key, said decrypted advertisement cue message identifying said insertion time for said advertisement, and enabling a display of said advertisement data; and
an decoder coupled to said decryption processor and conditioned to decode said broadcast data stream including said encrypted advertisement cue message and program data from a content provider.

11. The apparatus of claim 10, wherein
said advertisement cue message further includes data indicating that said advertisement is stored at the decoding apparatus, and source information for said advertisement for insertion.

12. The apparatus of claim 10, wherein
said broadcast data stream includes encrypted dummy cue messages indicating that said segment of said broadcast data stream should be skipped by said decoder, and
said decryption processor automatically skips a portion of a broadcast data stream in response to decrypting said dummy cue message

13. The apparatus of claim 10, wherein
said decryption processor automatically receives a key used to decrypt said advertisement cue messages for use in decoding said encrypted advertisement cue messages.

14. The apparatus of claim 10, wherein
said broadcast data stream includes format data identifying an order in which the segments of said broadcast data stream are to be decoded and in response to said format data, said decoder decodes said data stream in the identified order.

15. The apparatus of claim 10, wherein
said encrypted advertisement cue messages include watermark data incorporated in the program data, and
said description processor identifies said watermark data and inserts said advertisement associated with said watermark data within the decoded data stream.

16. A method of encoding a broadcast data stream comprising the activities of:
generating an advertisement cue message by a message processor, the advertisement cue message including:
data representing a advertisement to be inserted into a stream, and
data representing an insertion time within said broadcast data stream that is associated with said advertisement;
encrypting said advertisement cue message by an encryption processor using a encryption technique, said encrypted advertisement cue message masks said insertion time for said advertisement and prevents automatically skipping of said advertisement data; and
encoding a modified broadcast data stream including said encrypted advertisement cue message and program data from a content provider.

17. The method of claim 16, further comprising the activity of:
providing an encryption key used in said activity of encoding to a destination system enabling decrypting of said advertisement cue messages.

18. A method of decoding a broadcast data stream comprising:
receiving a broadcast data stream that includes encrypted advertisement cue messages, said encrypted advertisement cue messages including
data representing a advertisement to be inserted into a stream and
data representing an insertion time within said broadcast data stream that is associated with said advertisement;
decrypting said advertisement cue message using a decryption key by a decryption processor, said decrypted advertisement cue message identifying said insertion time for said advertisement and enabling a display of said advertisement data; and
decoding said broadcast data stream including said encrypted advertisement cue message and program data from a content provider.

19. The method of claim 18, further comprising the activity of
automatically acquiring a key to decrypt the received encrypted advertisement cue messages.
